(19) United States
(12) Patent Application Publication
(10) Pub. No.: US 2002/0006006 A1
(43) Pub. Date: Jan. 17, 2002

(54) Magnetic tape library apparatus

(76) Inventor: Takayuki Hirose, Ibaraki (JP)

Correspondence Address: McGinn & Gibb, PLLC, Suite 200, 8321 Old Courthouse Road, Vienna, VA, 22182-3817, US

(21) Appl. No.: 09/899,950

(22) Filed: Jul. 9, 2001

(30) Foreign Application Priority Data
Jul. 14, 2000 (JP) 2000-213546

(51) Int. Cl. G11B 17/00

(52) U.S. Cl. 360/69

(57) ABSTRACT

An object of the present invention is to prevent the collision between the carrier and the ejected tape cartridge by issuing a load command for leaving temporarily the tape cartridge in the tape drive. Load command control means issues a load command for tape cartridge drive, thereby confirming that the tape cartridge to be ejected has been brought back into the drive. Then, unload command control means issues an unload command, thereby confirming that the tape cartridge has been properly ejected from the drive. Carrier mechanism control means moves the carrier to the front of the drive, after confirming that the tape cartridge to be ejected has been brought back into the drive. Then, after confirming that the tape cartridge has been properly ejected from the drive, the ejected tape cartridge is taken into carrier.

### BACKGROUND OF THE INVENTION

1. Technical Field of the Invention

The present invention relates to a magnetic tape library apparatus provided with a magnetic tape drive with a self loading function by using a Load command, and particularly to a tape library apparatus wherein a carrier for carrying the tape cartridge may come into contact with the tape cartridge pushed out from the magnetic tape drive.

2. Description of the Prior Art

In a conventional tape library apparatus, a carrier for carrying the tape cartridge may possibly interfere with, or come into contact with the tape cartridge pushed out from the magnetic tape drive.

FIGS. 6A to 6I are plan views of above-mentioned carrier for explaining its moving path.

Further, a possible interference or collision is illustrated in FIG. 4B.

The carrier moves between a tape and a tape cartridge container, when the tape cartridge is pushed in the tape drive as shown in FIGS. 6A to 6E and the tape cartridge is pushed out from the tape drive as shown in FIGS. 6F to 6I.

The carrier collides with the tape cartridge at the interference portion as shown in FIG. 4B, when the carrier approaches the tape drive, after the ejection of the tape cartridge from the tape drive.

Therefore, the conventional magnetic tape library apparatus has a disadvantage that the tape cartridge ejected from the tape drive can not be taken into the carrier, when the carrier approaches the tape drive.

The tape cartridge library system as disclosed in JP 01-307965 A (1989) shortens an access time, when one of the cartridge is selected for write-in and read-out of data. Therefore, it is different from the present invention.

The auto-loading mechanism for a cartridge drive apparatus as disclosed in JP 09-231657 A (1997) loads automatically the cartridge again after completing ejecting the cartridge, thereby improving an operability of the auto-loading. Therefore, it is different from the present invention.

### SUMMARY OF THE INVENTION

An object of the present invention is to prevent the collision between the carrier and the ejected tape cartridge by issuing a load command for leaving temporarily the tape cartridge in the tape drive.

In general, the magnetic tape library apparatus of the present invention is provided with a drive with a self-loading function by using a load command wherein a tape cartridge ejected from the drive interferes with a path of a carrier for the tape cartridge.

The magnetic tape library apparatus comprises: a tape cartridge container for storing tape cartridges; a drive for ejecting a tape cartridge, when the tape cartridge is recovered back to the tape cartridge container; a carrier for transporting the tape cartridge between the tape cartridge container and the drive; and a CPU for issuing an load command, when the tape cartridge is to be ejected from the drive, and for moving the carrier to a front position of the drive, after confirming that the tape cartridge is temporarily taken into the drive on the basis of the load command.

Further, the timing control method for the magnetic tape library apparatus of the present comprises the steps of: issuing a load command is issued for drive; confirming that the tape cartridge to be ejected has been brought back into drive on the basis of the issued load command; moving the carrier to a front position of drive; issuing an unload command is issued for drive; confirming that the tape cartridge has been ejected from the drive on the basis of the unload command; taking the ejected cartridge into the carrier; and moving the carrier to the object slot in order to carry the tape cartridge into an object slot in the tape cartridge container.

Furthermore, the recording medium of the present invention is a recording medium for storing a computer program for controlling above-mentioned magnetic tape library apparatus of the present invention.

As described above, a tape cartridge to be ejected from a tape drive is brought back temporarily into the tape drive on the basis of a load command. Therefore, according to the present invention, a timing lag between carrier movement and cartridge ejection is prevented, thereby avoiding a collision between the carrier and the cartridge. Therefore, the ejected cartridge is taken into the carrier without fail.

### BRIEF EXPLANATION OF THE DRAWINGS

FIG. 1 is a block diagram of the magnetic tape library of the present invention.

FIG. 2 is a flow chart of tape cartridge ejection in the magnetic tape library of the present invention.

FIG. 3 is a block diagram for explaining an issue process of commands from CPU to tape drive in the magnetic tape library apparatus as shown in FIG. 1.

FIGS. 4A and 4B are plan views of the magnetic tape library apparatus for explaining the interference between the ejected tape cartridge and the carrier mechanism.

FIG. 5 is a block diagram of the magnetic tape library apparatus with a recording medium for recording a computer program for controlling the drive and carrier.

FIGS. 6A to 6I are plan views of a conventional magnetic tape library apparatus for explaining a moving path of a tape carrier mechanism.

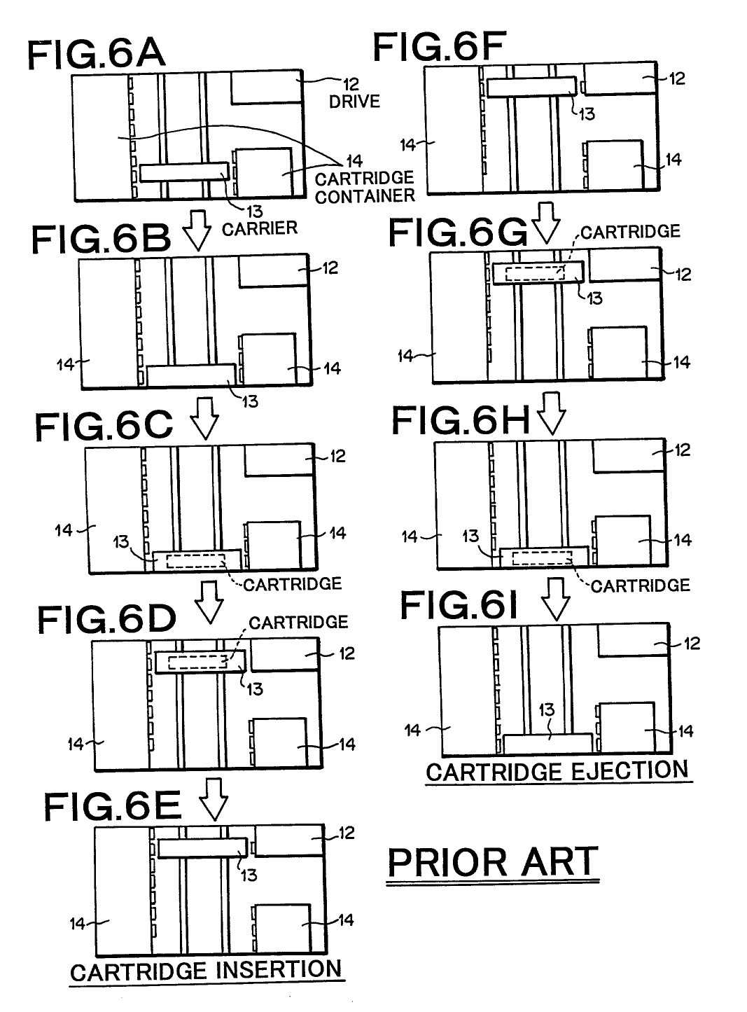

### PREFERRED EMBODIMENT OF THE INVENTION

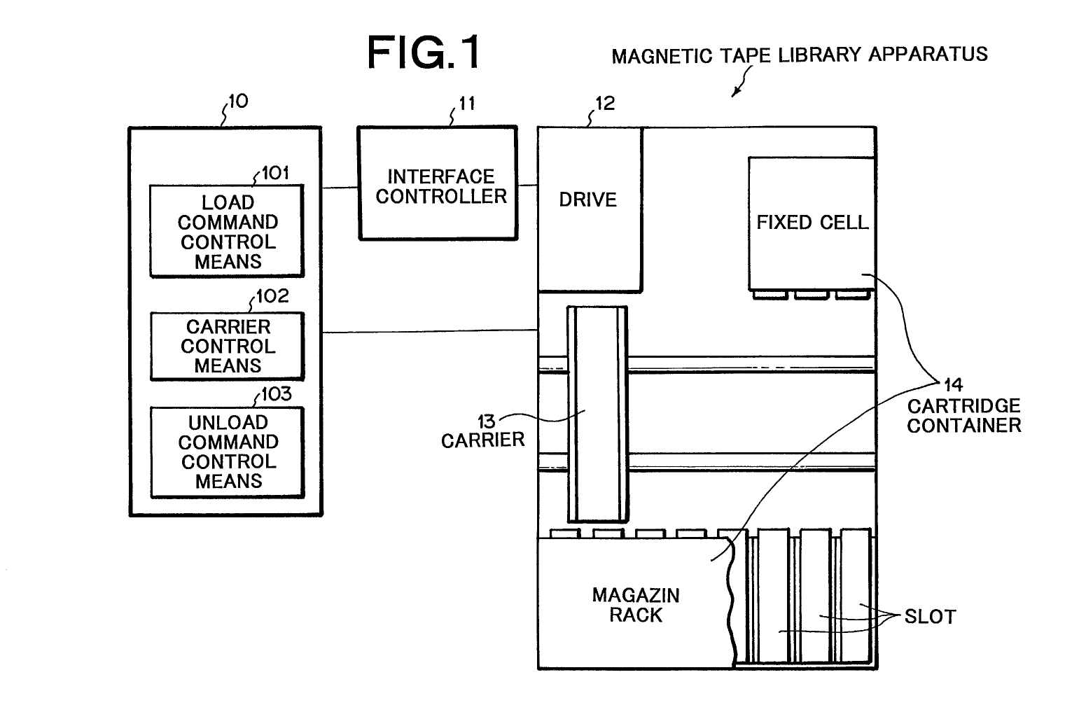

FIG. 1 is a block diagram of the magnetic tape library apparatus of the present invention.

The magnetic tape library apparatus as shown in FIG. 1 comprises CPU 10, interface controller 11, drive 12, carrier 13 and tape cartridge container 14.

CPU 10 comprises load command control means 101, carrier control means 102 and unload command control means 103.

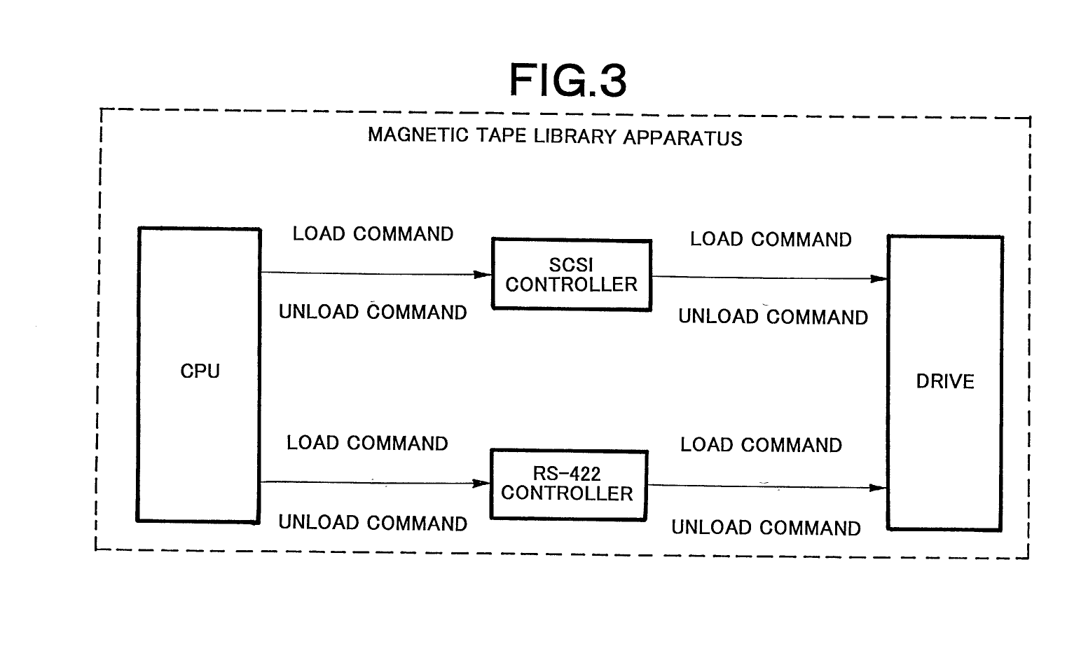

Interface controller 11 executes an interface between CPU 10 and drive 12, concerning with an issue and acquisition of commands. Interface controller 11 may be SCSI (small computer system interface) controller, or RS-422 (recommended standard-422) controller, as shown in FIG. 3.

Tape cartridge container 14 comprises a removable magazine rack and a fixed cell. A plurality of slots, each of which contains a tape cartridge, are provided for the magazine rack and fixed cell.

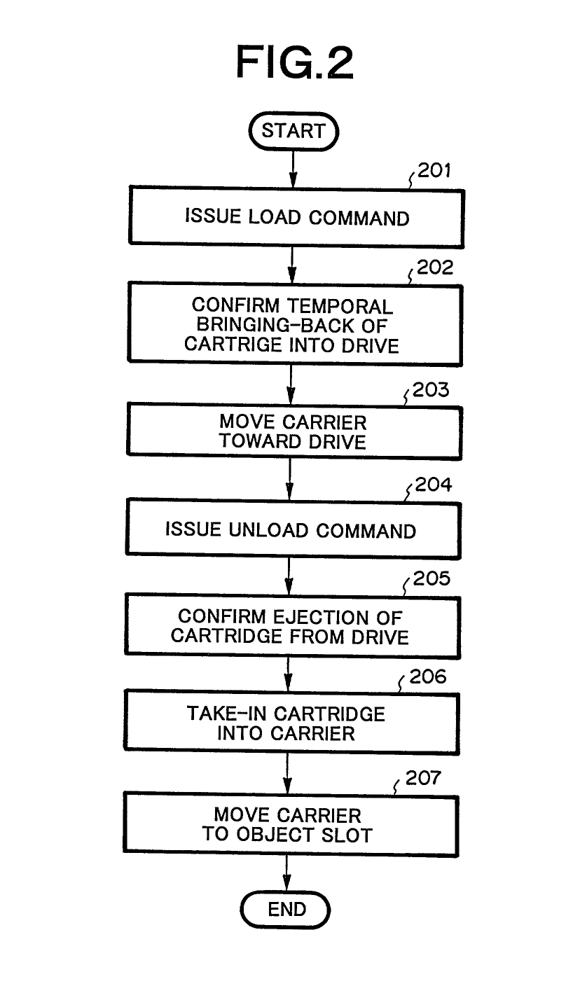

FIG. 2 is a flow chart for ejecting the tape cartridge from drive 12. The ejection process comprises the steps of issuing step 201 for issuing a load command, confirming step 202 for confirming whether the tape cartridge has been contained, moving step 203 for moving the carrier toward the drive 12, issuing step 204 for issuing an unload command, confirming step 205 for confirming whether the tape cartridge has been ejected from the drive 12, taking-in step 206 for taking in the tape cartridge and moving step 207 for moving the carrier toward an object slot.

FIG. 3 is a block diagram for explaining the issue of commands from CPU 10 to drive 12, when the tape cartridge is ejected.

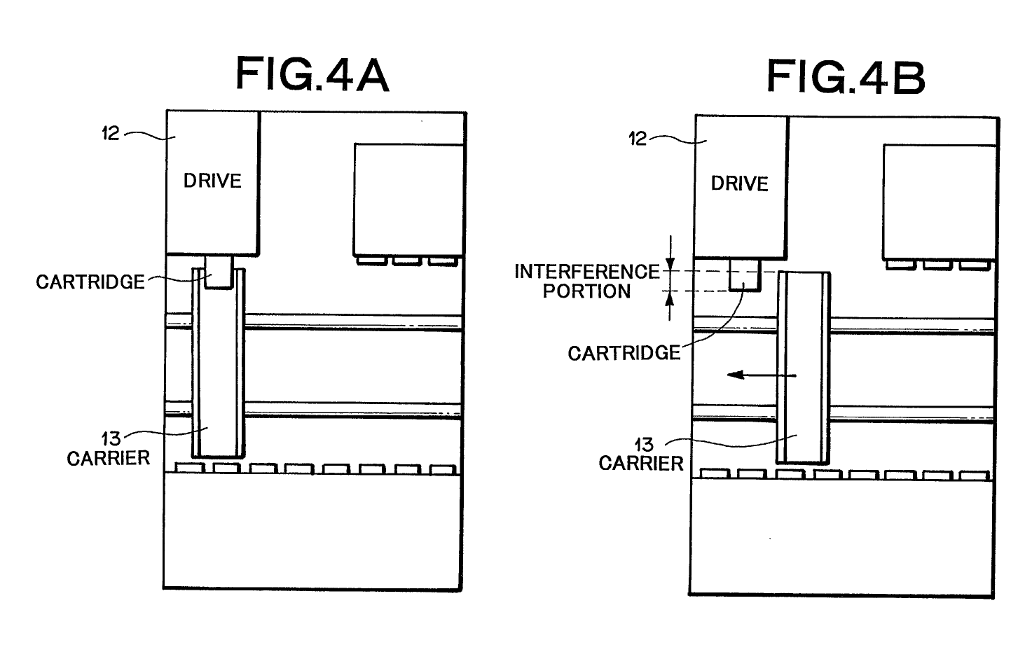

FIG. 4A is a plan view of the magnetic tape library apparatus, when the tape cartridge does not interfere with the carrier, while FIG. 4B is a plan view of the magnetic tape library apparatus, when the tape cartridge interferes with the carrier.

Next, the whole sequence of the ejection and movement of the tape cartridge from drive 12, referring to FIGS. 1 to 4B.

As shown in FIG. 3, load command control means 101 in CPU 10 issues a load command at step 201, when a tape cartridge loaded in drive 12 is to be ejected. The load command may be supported by SCSI or RS-422.

Drive 12 receives the load command through interface controller 11 such as SCSI or RS-422B and takes back the tape cartridge temporarily into drive 12.

Load command control means 101 confirms through interface controller 11 that the tape cartridge has been brought back perfectly into drive 12, at step 202.

After step 202, carrier control means 102 in CPU 10 moves carrier 13 from the present position to the front of drive 12, thereby standing by an ejection of the tape cartridge at step 203.

Next, as shown in FIG. 3, unload command control means 103 in CPU 10 issues an unload command at step 204. The unload command may be supported by interface controller such as SCSI or RS-422.

Drive 12 receives the unload command through interface controller 11 and ejects the tape cartridge on the basis of the unload command.

Unload command control means 103 confirms through interface controller 11 that the tape cartridge has been properly ejected from drive 12 at step 205.

After step 205, carrier control means 102 takes in the tape cartridge ejected from drive 12 into carrier 13 at step 206.

Finally, carrier control means 102 moves the carrier 13 toward an object slot in tape cartridge container 14 at step 207, thereby recovering the tape cartridge into the object slot.

Thus, the interference between the tape cartridge and carrier 13 as shown in FIG. 4B is avoided.

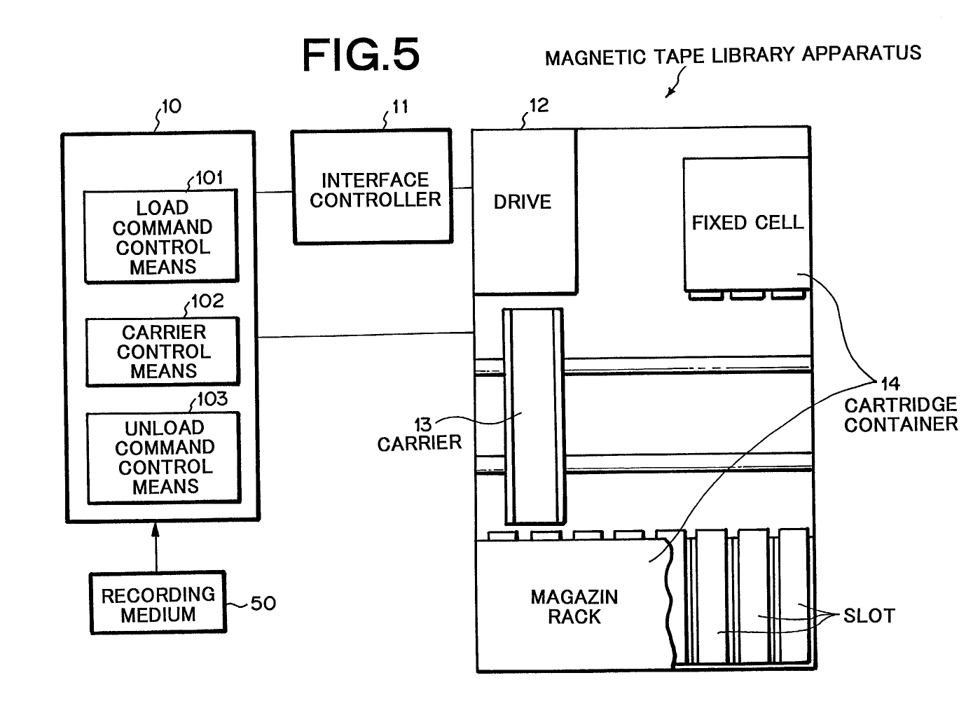

FIG. 5 is a block diagram of the magnetic tape library provided with a recording medium for recording a computer program, thereby operating the magnetic tape library.

As shown in FIG. 5, recording medium 50 storing a computer program for tape cartridge ejection is added to the magnetic tape library apparatus as shown in FIG. 1. Recording medium 50 may be a magnetic disc, semiconductor memory.

The computer program for tape cartridge ejection is read out from recording medium 50 to CPU 10, thereby controlling load command control means 101, carrier control means 102 and unload command control means 103. CPU 10 is operated by the computer program.

What is claimed is:

1. A magnetic tape library apparatus which comprises:
a tape cartridge container for storing tape cartridges;
a drive for ejecting a tape cartridge, when said tape cartridge is recovered back to said tape cartridge container;
a carrier for transporting said tape cartridge between said tape cartridge container and said drive; and
a CPU for issuing an load command, when said tape cartridge is to be ejected from said drive, and for moving said carrier to a front position of said drive, after confirming that said tape cartridge is temporarily taken into said drive on the basis of said load command.

2. The magnetic tape library apparatus according to claim 1, which further comprises an interface controller for interfacing said CPU and said drive, wherein said CPU comprises;
load command control means issuing a load command for said drive, and for confirming that said tape cartridge to be ejected is taken into said drive on the basis of said load command;
unload command control means for issuing an unload command for said drive, and for confirming that said tape cartridge is ejected from said drive on the basis of said unload command; and
carrier control means for moving said carrier to a front of said drive on the basis of a confirmation executed by said load command control means that said tape cartridge to be ejected is taken into said drive, for taking said tape cartridge into said carrier on the basis of a confirmation executed by said unload command control means that said tape cartridge to be ejected is ejected from said drive, and for moving said carrier to an object slot in said tape cartridge container.

3. The magnetic tape library apparatus according to claim 2, wherein said interface controller is a SCSI controller.

4. The magnetic tape library apparatus according to claim 2, wherein said interface controller is a RS-422 controller.

5. A timing control method for a magnetic tape library apparatus provided with a drive with a self-loading function by using a load command wherein a tape cartridge ejected from said drive interferes with a path of a carrier for said tape cartridge, which comprises the steps of:
issuing a load command is issued for drive;
confirming that the tape cartridge to be ejected has been brought back into drive on the basis of the issued load command;
moving said carrier to a front position of drive;
issuing an unload command is issued for drive;
confirming that said tape cartridge has been ejected from said drive on the basis of said unload command;
taking said ejected cartridge into said carrier; and
moving said carrier to the object slot in order to carry said tape cartridge into an object slot in said tape cartridge container.

6. A recording medium for storing a computer program for executing timing control method for a magnetic tape library apparatus provided with a drive with a self-loading function by using a load command wherein a tape cartridge ejected from said drive interferes with a path of a carrier for said tape cartridge, which comprises the steps of:
issuing a load command is issued for drive;
confirming that the tape cartridge to be ejected has been brought back into drive on the basis of the issued load command;
moving said carrier to a front position of drive;
issuing an unload command is issued for drive;
confirming that said tape cartridge has been ejected from said drive on the basis of said unload command;
taking said ejected cartridge into said carrier; and
moving said carrier to the object slot in order to carry said tape cartridge into an object slot in said tape cartridge container.
